(19) United States
(12) Patent Application Publication
(10) Pub. No.: US 2008/0064014 A1
(43) Pub. Date: Mar. 13, 2008

(54) SIMULATION-BASED NOVICE DRIVER INSTRUCTION SYSTEM AND METHOD

(75) Inventors: Richard Wojtczak, Scottsdale, AZ (US); Maria Wojtczak, Scottsdale, AZ (US)

Correspondence Address: JENNINGS, STROUSS & SALMON, P.L.C., 201 E. WASHINGTON ST., 11TH FLOOR, PHOENIX, AZ, 85004, US

(73) Assignee: DrivingMBA LLC

(21) Appl. No.: 11/854,525

(22) Filed: Sep. 12, 2007

Related U.S. Application Data
(60) Provisional application No. 60/844,148, filed on Sep. 12, 2006.

(51) Int. Cl. G09B 19/14

(52) U.S. Cl. 434/69

(57) ABSTRACT

The present invention provides for a simulation-based system and method for driver instruction using a highly sophisticated physical and computer-based simulation system combined with a novel simulation-based instruction methodology that allows a novice driver to learn driving fundamentals and advanced defensive driving skills in the safety of the simulator environment. The novelty of the present invention lies in the driving simulation aspect of the driver instruction disclosed herein combined with the novel method of instruction disclosed herein. The simulation-based system and method provides numerous advantages over any other driving instruction system or method currently in use or known in the art.

### CLAIM TO DOMESTIC PRIORITY

This application claims the benefit of priority of U.S. provisional application Ser. No. 60/844,148 filed Sep. 12, 2006.

### FIELD OF THE INVENTION

This invention relates in general to the field of driving instruction, and more specifically to a novel and improved instruction and feedback system and method for novice drivers, including, but not limited to, young, teenage drivers learning to drive for the first time, that utilizes a highly sophisticated physical and computer-based simulation system.

### BACKGROUND OF THE INVENTION

Although teens make up only 7 percent of the total driving population, they account for 14 percent of all fatalities. Car accidents are the leading cause of death for young people between the ages of 15 and 19 years. In the year 2000 alone, 4,877 teen deaths were recorded as a result of preventable crashes. Today, 16-year-old girls are just as likely to crash as 16-year-old boys, and the fatality rate for girls ages 15 to 20 increased 4 percent from 1990 to 2000.

Then, of course, there are the many innocent victims who die in car crashes with teens each year. While many teens die from lack of training and experience, some perish as innocent passengers of their friends who have a lack of training and experience. In 2000 alone, 2,132 teens were killed while riding with another young driver.

Teen crashes have become an epidemic; teens are risk takers. Of those involved in crashes in 2000, 36 percent of teens had been drinking and 58 percent were speeding at the time of the crash, according to the NHTSA.

Dennis Doverspike, PhD, a professor of psychology at the University of Akron in Ohio who studies teen risk-taking attitudes, found that it takes several years for driving to become an automatic response and teens don't have these years of experience under their belts given present driving instruction provided by private services or schools. Most teens never have to practice driving in inclement weather or high-speed traffic before getting a license and when placed in one of these situations, they don't know how to respond.

Unlike past generations, many of today's teens don't learn how to drive from their parents. Instead, they are sent to drivers' education programs—something that is partly to blame for the high rate of teen accidents. Traditional drivers' education doesn't necessarily produce safe drivers. Instead, it comes down to a teen's demeanor and overall experience level which is not necessarily improved by traditional drivers' education. Parents send in a check thinking that their child will be trained in all aspects of driving, but that just doesn't happen. Instead, teens are taught only the basics and how to pass the driver's test.

In some cases, the on-road driving instructors themselves may be poor examples of safe driving. For instance, a recent survey of driving schools in New York state found that 46 of 257 instructors had criminal records and some had suspended licenses. Sixteen percent owned vehicles that failed simple safety inspections. Consequently, many parents never realize what a risk their teens are taking when they get behind the wheel.

Take the case of Danielle Simas, 17, of Shrewsbury, Mass. On Feb. 25, 2000, Danielle was driving to her boyfriend's house on the interstate, when she attempted to switch into the center lane. She almost collided with the car next to her and quickly veered back into her lane. As she swerved, her Nissan Maxima hit an icy patch of road, skidded, and crashed into an embankment.

The impact of the collision propelled Danielle's body from the car into the road, where she was hit by an oncoming car and died instantly. The first things her parents asked the police were, “Was she driving fast?” “No.” “Did she have her seatbelt on?” “Yes.” “Was she using her cell phone?” “No, she just wasn't experienced enough to handle the icy conditions.”

Her parents had sent Danielle to what they thought was the best drivers' education program in town, but they learned later that she'd never been given skid training. She didn't know what to do when her car lost control.

As noted above, presently teens are taught only the basics of driving and how to pass the driver's test. Present driving instruction is often limited to classroom instruction followed by driving exercise and eventually a driving program where the student driver navigates the road with a driving instructor. As noted above, most teens never have to practice driving in inclement weather or high-speed traffic before getting a license and when placed in one of these situations, they don't know how to respond. This is because most teens taking drivers' education during the summer months when inclement weather is rarely an issue, and driving instructors often avoid high-speed traffic or rush hour traffic when providing driving instruction to teenagers.

FIG. 1 illustrates the standard approach in driving programs that have simulator training incorporated as a component. Even if these present driving programs incorporate some type of simulation, the simulation is often comprised of a standard PC and a joystick. Further, the simulator as well as simulation software lacks the elements necessary to provide an effective driver education course.

First, using a PC-based simulation, the novice driver fails to experience the physical sensations of driving. Further, PC-based simulators using joysticks are more akin to video games than actual driving instruction. Further, the PC-based simulation systems do not have the capability to simulate an actual driving experience, including providing a wide viewing range and simulating various driving conditions.

Specifically, as shown in FIG. 1, these simulations may not expose students to various hazardous situations during drives, and learning only occurs by experiencing problems and developing an understanding of what should be done. Further, even if students are exposed to hazardous simulations, these simulations may allow a driver to be successful with an unsafe or less than desired response. For example, in current simulations used for novice drivers, the driver could pass on the right to avoid a situation or just drive five miles an hour in a blizzard and still pass the simulation. While this type of response would allow the novice driver to pass the simulation, the actions would do nothing to prepare the novice driver for on-road driving in those conditions.

Similarly, a driver may drive so cautiously to avoid any problems, and thus, not learn through developing an understanding of how to realistically respond to problems. Finally, in simulations presently used in driver instruction, re-drives or second tries only repeat the first simulation and thus, the student knows what to expect, and the learning is limited by the type of simulation used and the driving instruction method employed by systems that attempt to use basic simulation packages.

Presently, there is no existing system and method that uses a highly sophisticated physical and computer-based simulation system that provides the necessary level, diversity and type of simulation, combined with the necessary simulation instruction and methodology to effectively teach drivers how to drive safely and react in a timely and proper manner to numerous, varying, hazardous situations.

Thus, a need exists for a simulation-based system and method that would provide novice driving instruction in a more effective manner and result in safer drivers who are prepared to drive under numerous hazardous conditions and react more quickly to dangerous and unexpected situations in a correct manner.

### BRIEF DESCRIPTION OF THE FIGURES

FIG. 1 is a flowchart illustrating a present approach to drivers' instruction incorporating simulations.

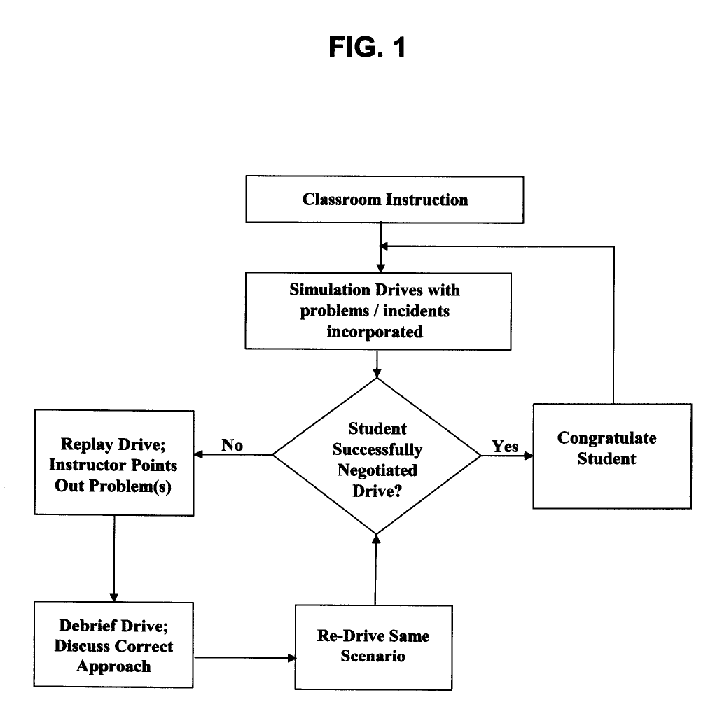

FIG. 2 is a flowchart generally illustrating one embodiment of the disclosed system and method.

FIG. 3 is a flowchart illustrating in further detail one embodiment of the disclosed system and method.

FIG. 4 is a chart illustrating in detail one embodiment of the disclosed system and method as used in the state of Arizona.

### DETAILED DESCRIPTION OF VARIOUS EMBODIMENTS

The present invention provides for a simulation-based system and method for driver instruction using a highly sophisticated physical and computer-based simulation system combined with a novel simulation-based instruction methodology that allows a novice driver to learn driving fundamentals and advanced defensive driving skills in the safety of the simulator environment. Therefore, it is noted that the present disclosure will focus primarily on the novel and improved simulation and related instruction disclosed herein, but that for maximum effectiveness in driver education, the driving simulations components should be combined with written materials and tests, as well as on-road instruction in a vehicle.

According to the present invention, the novelty of the present invention rests in the use of a highly sophisticated simulation system that allows novice drivers to experience both the physical sensations that accompany on-road driving as well as a sophisticated simulation software package that provides for the ability to simulate numerous on-road driving conditions, create unrecoverable situations, and allow a novice driver to experience and navigate various types of potentially threatening scenarios, all in a no risk, safe environment. These highly sophisticated simulators have only previously been used for pilot and astronaut training, or for training emergency responders and emergency vehicle operators. Examples of manufacturers of these highly sophisticated simulators include MPRI and FAAC. Preferably two simulation packages are used, but are not required. In embodiments where two simulation packages are used, one focuses on initial driving instruction and the other on defensive driving skills. As those two simulation systems are included in the method, they are herein referred to as Level One and Level Two.

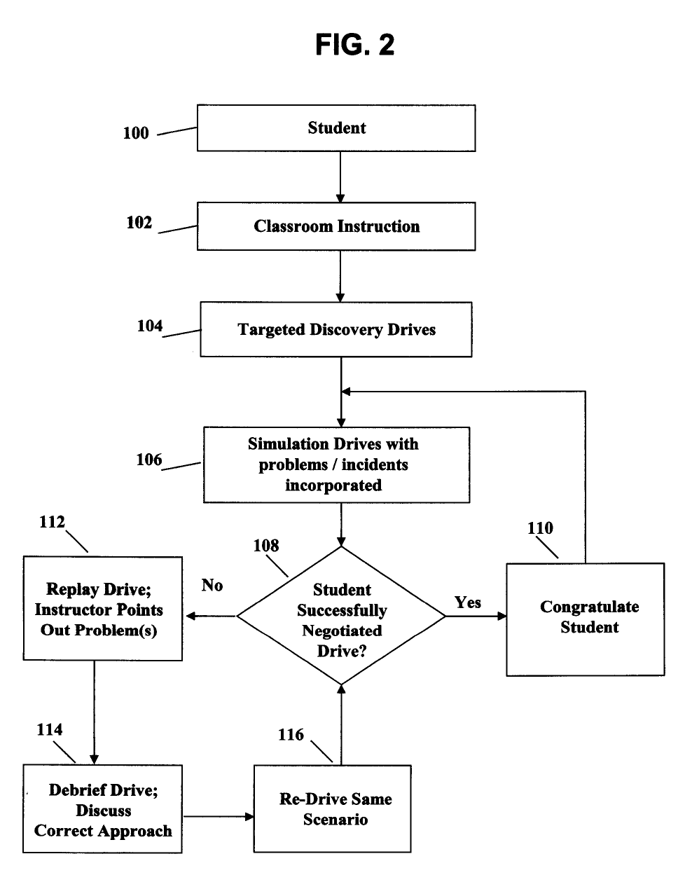

This invention is focused on instruction for novice drivers, including, but not limited to, teenage drivers learning to drive for the first time. However, it is recognized that unlicensed novice drivers may be of any age and/or who are attempting to get a non-commercial driver's license. FIG. 2 is a flowchart generally illustrating one embodiment of the disclosed system and method. Student 100 is a novice driver.

As shown in FIG. 2, the disclosed novel method for improved driver education begins with classroom instruction 102. Following a predetermined amount of classroom instruction, the student engages in targeted discovery drives 104. The purpose of the targeted discovery drives is to increase student awareness of the vehicle itself, including the limitations of the vehicles, as well as the student's personal limitations in driving the vehicle.

In targeted discovery drives 104, the student may often be set up for failure, including crashing, losing control of the vehicle and other scenarios, which force the student to face his limitations behind the wheel and learn how they would react without further instruction - in short, to demonstrate to the student driver why he needs further simulation practice and instruction. With teenage drivers, this is a key step in overcoming the invincibility and risk-taking mentality many teens have when approaching driving.

Next, drivers are taken through simulation drives 106 with problems and incidents incorporated. These are also referred to herein as Scripted Drives 106. Again, the same type of forced crashing or losing control can be incorporated in this step. In this step time is spent with the simulator practicing the recognition and avoidance of hazardous situations. Because of the lessons learned in discovery drives 104, students should already be aware of what options they have and of the conditions that can create problems.

In step 108, if the student successfully negotiates the drive, the student is congratulated in step 110. If the student does not successfully negotiate the drive, the instructor points out the problems in step 112, debriefs the drive and suggests the correct approach in step 114 and then the student re-drives the same or similar simulated scenario in step 116. This approach is repeated until the student successfully negotiates the simulated drive in step 108 and the student is congratulated in step 110.

According to the present disclosure, the present system and method, a student is taken through repetitive practice of safe driving skills to quickly and effectively develop proper driving habits in this sophisticated simulator environment. Students experience years of unusual driving events in a highly compressed timeframe for the purpose of developing awareness of limitations, and understanding of actions that can be taken to safely negotiate similar events—all in the no-risk environment of the simulator.

The instructor facilitates the learning process by observing, commenting on, and correcting unsafe practices in the simulated environment before they become a critical event on the road. Feedback is given at every stage of the simulation learning process, both to the student and the parents (where possible) to reinforce proper behavior in the no-risk environment of the simulator, which allows parents to provide further guidance for practice sessions behind the wheel.

More specifically, the output provided according to this novel system is feedback to the student on areas to continue to work on, and formal assessment output for the level completed, resulting in a better-trained, safer driver equipped with the knowledge and skills to effectively practice defensive driving tactics and better control a vehicle under all conditions.

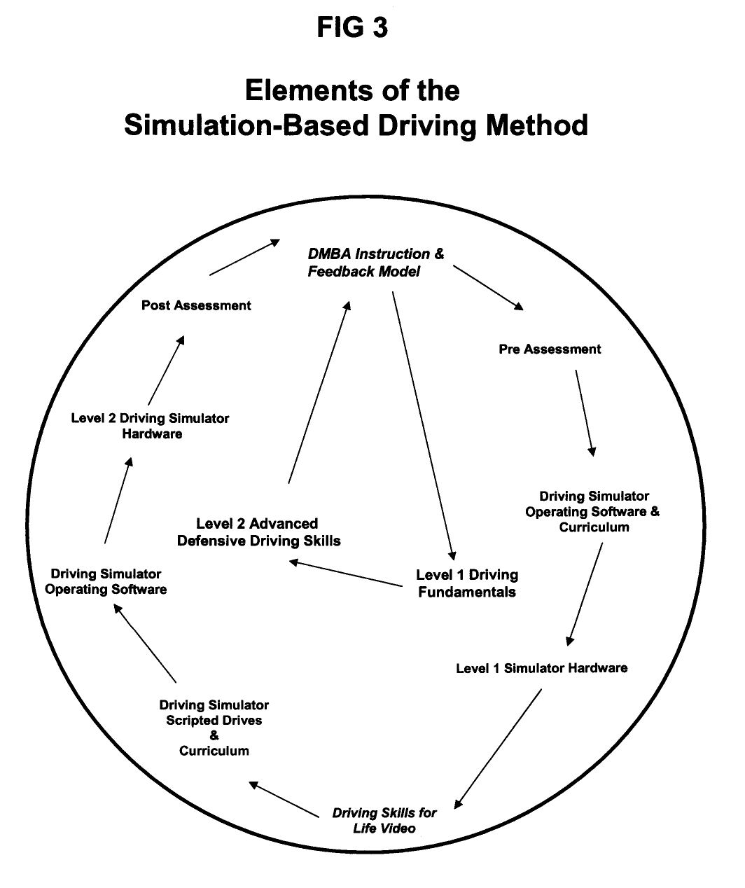

FIG. 3 illustrates how the elements of the disclosed system and method are brought together for the purpose of reducing the risk and magnitude of death, injury and property damage caused by inexperienced and untrained drivers, such as teenage drivers. This is accomplished by using simulators to teach students how to drive through experience in a no-risk environment.

Turning now to a general description of the disclosed system of the present invention, in one embodiment, the disclosed novel system for improved driver is comprised of a Level One Simulator package, including Level One Simulator Hardware and Level One Simulator Software and Curriculum. Additionally, the system includes a Level Two Simulator package including Level Two Assessment Software, Level Two Proprietary scripted drives and Curriculum, Level Two Simulator Hardware, and Level Two Simulator Software. These packages combined with the novel methodology provide the core novelty to the present invention and are discussed in greater detail below. Further, the disclosed system and method includes specific instructor guidelines, requirements and novel methodology for using and implement the simulator system, also discussed in more detail below. In some embodiments, a video, for example Driving Skills for Life Video, is also incorporated into the disclosed method.

The Driving Skills for Life Video was developed and provided by Ford Motor Company and the GHSA. In using the video, the instructor emphasizes and elaborates on key elements in the video. In some embodiments, the participants fill out a pre-test. The video is reviewed, with several pauses for additional input from the instructor and for interaction regarding content covered. Participants reconsider the responses recorded on the pre-test after viewing the video.

In some embodiments, this video is used only with drivers who have an excess of a pre-determined, for example 20, hours of on-road driving experience. In some embodiments, the video is used with novice drivers who have a basic knowledge of the key elements that form the basis for the Level Two training curriculum. It is also recommended that the instructor have knowledge of the basic competency level of the novice driver participants.

Taking each piece of the disclosed system in turn, a detailed description of the functionality and use of each according to the present invention is provided below. As noted above the Level One Simulator package includes Level One Simulator Hardware and Level One Driving Simulator Operating Software and Curriculum.

The Level One Simulator Hardware includes vehicle cab specifications (seat configuration, control placement) for the desired student experience, realistic vehicle operating controls, including steering, brake, accelerator, turn signal, gear shift, windshield wipers, and headlights, among others. Computer controllers are associated with all operating controls as well as visual displays, and the capability to simulate scanning at intersections and for blind spot checks.

According to the present disclosure, the Level One Simulator Hardware should be capable of visual and tactile feedback to the student driver based on the simulated results and proper execution of the provided lessons and the Simulator Software, described below.

The Level One Driving Simulator Operating Software and Curriculum includes vehicle-specific operating characteristics, environmental condition varieties, scripted drives developed for the desired curriculum and lessons, optional instructor- or student-controlled replays, combined with the simulator hardware, described above, to run the operating software. According to the present disclosure, the simulator operating software should be capable of recorded drives for possible review and playback and experiential learning opportunities as defined by the scripted scenarios.

In using the Level One Simulator package according to the present method, the instructor or student initiates software execution for the desired lesson sequence. The student manipulates the cab hardware to control the movement of the simulated vehicle in relation to the driving environment selected. The steering, braking, and accelerator hardware responds with feedback appropriate to the simulated outcome.

Further, the student or instructor initiates the lesson plans included in the curriculum, with each lesson building on preceding lessons to reinforce learning. The software monitors the student's input and accurately presents the simulated driving experience, allowing interaction with other vehicles and objects. The student driver interacts with the unfolding scenario, causing the vehicle under control to maneuver safely or alternatively experience error or even collision conditions.

If the student varies outside the pre-determined range of acceptable control over the vehicle, the software triggers error conditions and forces a restart. The instructor monitors the student's progress, providing correction, feedback, reinforcement as appropriate. The software records the information as the scenario progresses for possible review at the conclusion of the drive if teachable moments occur.

In some embodiments, a pre-Level Two Assessment is provided. In this embodiment, it is recommended that the novice driver have a predetermined amount on-road experience, for example, a minimum of 20 hours road experience. The assessment software can be any driving assessment software known in the art combined with computer hardware appropriate to the proper execution of the assessment software. In this embodiment, the instructor should be trained in reviewing assessment results.

In this embodiment, the student interacts appropriately and according to the instructions with the assessment hardware and software. The assessment software records the student's performance relative to the reference group. The assessment software produces a report analyzing student's performance. The instructor analyzes the report, provides additional feedback to student on results, and records particular areas of concern for use in guiding special emphasis during Level Two training sessions. Results from this assessment are stored for comparison to post-Level Two training assessment.

The next step in the method is the utilization of the Level Two Simulator package for Scripted Simulator Drives. As noted above, the Level Two Simulator package is used primarily for targeted discovery drives (FIG. 2, step 104). Also, as noted above, the Level Two Simulator package includes Level Two Simulator Hardware and Level Two Driving Simulator Operating Software.

The Level Two Driving Simulator Hardware includes vehicle cab specifications (seat configuration, control placement) for the desired student experience, realistic vehicle operating controls, including steering, brake, accelerator, turn signal, gear shift, windshield wipers, and headlights, among others. Computer controllers are associated with all operating controls as well as visual displays, a minimum of more than approximately a 160-degree field of view to provide adequate scanning capability while negotiating intersections, and capability to simulate blind spot checks for proper lane change procedure. The minimum of more than approximately 160-degree field of view is particularly novel to the present invention.

According to the present disclosure, the Level Two Driving Simulator Hardware is capable of providing visual and tactile feedback to the student driver based on the simulated results. Further the hardware is capable of proper execution of the scripted drives and the Simulator Software, as described below.

The Level Two Driving Simulator Operating Software includes the ability to program and modify the vehicle-specific operating characteristics, the vehicle type desired for the selected drive, the environmental characteristics desired, the scripted drives developed for the desired experience, and provide instructor controlled replays. This is combined with the simulator hardware, described above to run the operating software.

According to the present invention, the Level Two Driving Simulator Operating Software is capable of recorded drives for possible review and playback, as well as experiential learning opportunities as defined by the scripted scenarios and instructor controlled events.

In utilizing the Level Two Simulator package according to the present method, the instructor initiates software execution to provide the desired experience. The student manipulates the cab hardware to control the movement of the simulated vehicle in relation to the driving environment selected. The steering, braking, and accelerator hardware respond with feedback appropriate to the simulated outcome.

Further, the instructor initiates the lesson plans included in the curriculum, with each lesson building on preceding lessons to reinforce learning. The software monitors the student's input and accurately presents the simulated driving experience, allowing interaction with other vehicles and objects. The student driver interacts with the unfolding scenario, causing the vehicle under control to maneuver safely or, alternatively, experience collision conditions. The instructor monitors the student's driving behavior and provides feedback as appropriate to ensure development of the desired competencies. Finally, the software records the information as the scenario progresses for possible review at the conclusion of the drive if teachable moments occur.

The Scripted Drives incorporate learning objectives defined in the novel curriculum, as described herein, and script authoring tools are available for use with the chosen simulator vendor. A trained developer may be used to produce and test the desired scripts.

According to the present disclosure, Scripted Drives include scripted routes and actions that are produced or selected by the trained developer or instructor to create the desired experiential learning conditions. At the appropriate or pre-determined point in the instructional process, the student drives the scripted route and experiences the desired situation.

The drive is recorded by the simulator and can be reviewed to highlight actions and techniques to employ as a defensive driver. The instructor reviews key points with the student to ensure understanding and development of competence. The student can drive the same or similar scripted route to practice and demonstrate knowledge gained.

Here, the student gains an awareness of hazardous situations and conditions and understanding of techniques to avoid same. The student also develops and practices both avoidance and recovery techniques. As shown in FIG. 2, step 110, the instructor acknowledges the student's mastery of the desired capability and congratulates the student.

In some embodiments, a Post Level Two Assessment is provided. A Post Level Two Assessment is intended for a driver who has experienced the Level Two training curriculum. As with the Pre-Level Two Assessment, the assessment software can be any driving assessment software known in the art combined with computer hardware appropriate to the proper execution of the assessment software, and is preferably the same. In this embodiment, the instructor should be trained in reviewing assessment results.

In this embodiment, the student interacts appropriately and according to the instructions with the assessment hardware and software. The assessment software records the student's performance relative to the reference group. The assessment software produces a report analyzing student's performance.

The instructor analyzes report, provides additional feedback to student and parents for continued improvement areas. Results are stored for comparison to initial assessment and periodic analysis of program's effectiveness.

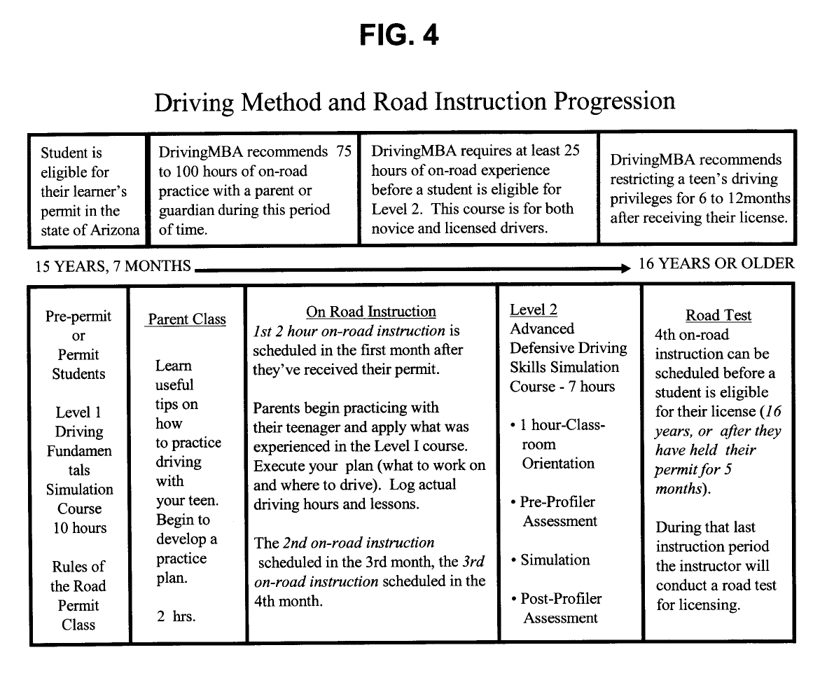

FIG. 4 is a chart illustrating in detail one embodiment of the disclosed system and method as used in the state of Arizona in combination with written instruction, a permit test, and on-road instruction.

The above-described system and method has several distinct advantages. First, the driver is exposed to simulated hazardous situations, which create student awareness of the limitations of the vehicle as well as personal limitations in driving the vehicle under a plethora of hazardous conditions, including various types of inclement weather, roadside hazards, moving obstacles, and other vehicles operating in an unsafe manner. Second, an alternate embodiment of the system allows a driver to quickly develop sound, safe driving habits through repetition on the Level One simulator. Third, the driver can be set up for failure, so no matter how cautiously or effectively the driver believes he is navigating the simulation, the driver will experience situations in which he crashes or is forced to react to an out-of-control vehicle.

Further, the driver doesn't merely re-drive the same scenario, but the scenario can be ever-changing, simulating actual driving and enhancing awareness of the roadside, the vehicle and more accurately imitating on-road experiences. Finally, the novel use of a highly sophisticated physical and computer-based simulation system and accompanying instruction method more effectively, more efficiently and more safely prepare novice drivers to handle many different situations, timely react in a proper and safe manner, and reduce the likelihood of teenage accidents—all in a no risk environment.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive nor limit the invention to the precise form disclosed and many modifications and variations are possible in the light of the above teachings. The embodiments were chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out the invention.

What is claimed is:

1. A system for providing driving instruction to novice drivers, comprising:
a first simulator, including vehicle operating controls, computer controllers associated with the vehicle operating controls, and visual displays, wherein the visual displays are capable of providing more than approximately a 160-degree field of view, wherein the first simulator is capable of providing visual feedback and tactile feedback to the novice driver based on the actions of the novice driver; and
an instruction manual, capable of being implemented by an instructor, the instruction manual including instructions for using the simulator to provide the novice driver a variety of driving experiences and giving feedback to the novice driver.

2. The system of claim 1, further including a second simulator, including vehicle operating controls, computer controllers associated with the vehicle operating controls, and visual displays, wherein the second simulator is capable of providing the novice driver with repetitive simulated scenarios, visual feedback and tactile feedback based on the actions of the novice driver.

3. The system of claim 1, further including a driving skills video.

4. The system of claim 1, further including a pre-assessment administered prior to use of the simulator.

5. The system of claim 1, further including a post-assessment administered after use of the simulator.

6. A method for providing driving instruction to novice drivers, comprising:
exposing the novice driver to simulated drives in a first simulator, wherein the simulator includes vehicle operating controls, computer controllers associated with the vehicle operating controls, and visual displays, wherein the visual displays are capable of providing more than approximately a 160-degree field of view, and the simulator is capable of providing visual feedback and tactile feedback to the novice driver based on the actions of the novice driver; and
providing instruction to the novice driver based on the results of the simulated drive.

7. The method of claim 6, wherein the driving instrution further includes exposing the novice driver to simulated drives in a second simulator, wherein the simulator includes vehicle operating controls, computer controllers associated with the vehicle operating controls, and visual displays, and the second simulator is capable of providing the novice driver with repetitive simulated scenarios, visual feedback and tactile feedback based on the actions of the novice driver.

8. The method of claim 6, further including providing an instruction manual, capable of being implemented by an instructor, the instruction manual including instructions for using the simulator to provide the novice driver a variety of driving experiences and giving feedback to the novice driver.

9. The method of claim 6, further including providing a driving skills video.

10. The method of claim 6, further including administering a first assessment test prior to exposing the novice to simulated drives.

11. The method of claim 6, further including administering a second assessment test after exposing the novice to simulated drives.

12. The method of claim 6, further including offering a parent instruction class.

13. The method of claim 6, further including on-road instruction.

14. The method of claim 6, further including a road test.

15. The method of claim 14, wherein the results of the road test are determinative of the ability of the driver to obtain a driver's license.

16. A method for providing driving instruction to novice drivers, comprising:
exposing the novice driver to simulated drives in a first simulator, wherein the simulator includes vehicle operating controls, computer controllers associated with the vehicle operating controls, and visual displays, wherein the visual displays are capable of providing more than approximately a 160-degree field of view, and the simulator is capable of providing visual feedback and tactile feedback to the novice driver based on the actions of the novice driver; and
exposing the novice driver to simulated drives a second simulator, wherein the simulator includes vehicle operating controls, computer controllers associated with the vehicle operating controls, and visual displays, and the second simulator is capable of providing the novice driver with repetitive simulated scenarios, visual feedback and tactile feedback based on the actions of the novice driver.

17. The method of claim 16, further including administering a first assessment test prior to the simulated drives in the first simulator.

18. The method of claim 16, further including administering a second assessment test after the simulated drives in the first simulator.

19. The method of claim 16, further including administering a third assessment test after the simulated drives in the second simulator.

20. The method of claim 16, further including administering a road test after the simulated drives in the second simulator.
